(19) United States
(12) Patent Application Publication
(10) Pub. No.: US 2003/0161325 A1
(43) Pub. Date: Aug. 28, 2003

(54) Transporting information in a communication system

(76) Inventor: Sami Kekki, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/257,160

(22) PCT Filed: Apr. 10, 2001
(86) PCT No.: PCT/EP01/04131

(51) Int. Cl. H04Q 11/04

(52) U.S. Cl. 370/395.43

(57) ABSTRACT

The present invention relates to transportation of information between nodes of a communication system. Information is transmitted by first transport entities from a first node to a second node and by second transport entities from the second node. Allowed transportation delays are defined for the first transport entities, and the first transport entities are distributed into transportation classes based on the allowed transportation delays. An indicator is assigned for a transport entity that is to be transported from the first node based on the transportation class thereof and also on information of a transport entity that is to be transported from the second node at a given moment of time. After the transport has been received at the second node information contained therein is inserted into a second transport entity, the selection thereof being based on the indicator.

### FIELD OF THE INVENTION

The present invention relates to transport of data in a packet switched communication system.

### BACKGROUND OF THE INVENTION

A communication system may provide the user, or more precisely, user equipment or terminal, with a circuit switched and/or a packet switched service. From these services the packet switched services can be defined in general as services that are capable of transporting information in data packets or similar data units between two signalling points, such as between two terminals or between a terminal and a node in the network or between two network nodes.

A communications system typically operates in accordance with a standard or specification which sets out what the various elements of the network are permitted to do and how that should be achieved For example, the standard or specification may define whether the user, or more precisely, user equipment or terminal is provided with circuit switched and/or packet switched service. The standard or specification may also define the various communication protocols and/or parameters which shall be used for the connection. In other words, the standards and/or specifications define the “rules” on which the communication can be based on. The various functions that are based on these rules may be arranged in predefined layers, e.g. to so called protocol stacks.

A packet switched data network may be a communication network that is based on use of a fixed line communication media. The packet switched data network may also use a wireless connection for at least a portion of a connection between the two signalling points. ATM/AAL2 (Asynchronous Transfer Mode/ATM Adaptation Layer type 2) and IP (Internet Protocol) based data networks and various Local Area Networks (LAN) are mentioned herein as examples of the packet switched networks. Examples of communication networks that are capable of providing wireless packet switched services, such as IP (Internet Protocol) or ATM/AAL2 based packet data transmissions, include, without limiting to these, the GSM (Global System for Mobile communications) based GPRS (General Packet Radio Service) network, EDGE (enhanced data rate for GSM evolution) Mobile Data Network and third generation telecommunication systems such as the CDMA (code division multiple access) or TDMA (time division multiple access) based 3^{rd} generation telecommunication systems that are sometimes referred to as Universal Mobile Telecommunication System (UMTS), and IMT 2000 (International Mobile Telecommunication System 2000). All these relate to the transfer of data to and from mobile stations or similar user equipment providing the user thereof with a wireless interface for the data transmission.

In a typical wireless communication system a base station (BS) serves user equipment via a wireless interface. For example, in the WCDMA radio access network the user equipment is served by Node B, which is connected to and controlled by an element called as a radio network controller (RNC) node over e.g. an Iub interface. The RNC element may be connected to and controlled by a mobile switching center (MSC), a serving GPRS support node (SGSN) or similar controller facility in the core network side of the communication system. The interface between the access network and the core network is often referred to as an Iu interface. Several connections or calls may be established simultaneously over the interface between the core and access networks. The core network may transmit various information that associate with the connection over the interface. The information may include quality of service (QoS) information defining, among other possible parameters, characteristics of the radio link, e.g. the allowed delay in the transmission of information frames in the system. The term radio link refers to the part of the connection or “call” that is transported over the radio interface. In the access network the same part of the call is transported over the Iub and Iur interfaces by a frame protocol (FP) connection. The characteristics of the radio link are typically defined by the access network controller based on information that associates with the call and that has been received from one or more of the controllers of the core network. The information may include, for example, quality of service parameters.

In the proposed data communication systems, such as the UMTS, data streams may transported via various communication channels that may be referred to as transport channels. Examples of the transport channels, without limiting to these, include a dedicated channel (DHC), a downlink shared channel (DSCH) and a common packet channel (CPCH). A specific frame protocol. (FP) may be used in the UMTS for conveying the transport channels between the base station and the radio network controller and also between two or several network controllers. The frame protocol frames are to be inserted into the radio frames to be transmitted over the radio link. The exemplifying frame protocols have been specified in more detail e.g. in 3GPP (3^{rd} Generation Partnership Project) specifications TS25.427, TS25.425 and TS 25.435.

Packet switched systems may use timing parameters to define a window within which the data packets belonging to a data stream should have been received. To keep the synchronisation of a data stream the controller node may include an appropriate connection identifier to the frames that are to be transmitted to the user equipment. An example of the identifier is a Connection Frame Number (CFN) that may be added to a DCH FP frame or to the DSCH TFI Signalling control frame. A frame protocol frame is typically provided with a header, the header including a field for the connection frame number. In the downlink direction (i.e. in direction from the RNC node to the base station) the RNC node inserts to the field a frame number in which it wants the base station to transmit the frame in the radio interface. In the radio link the radio frames are sent sequentially (e.g. in an order defined by frame Nos., such as . . . 56, 57, 58, 59, . . . ). The subsequent frames may be transmitted, for example, with 10 ms intervals, in which case a frame number equals 10 ms in the time axis. The RNC controller node of the radio access network is aware of the frame number that is to be transmitted at the radio link (interface) of the base station at a given moment.

If a FP frame of a data stream arrives too late or too early (i.e. outside a receiving window) to the base station and thus cannot be inserted into a radio frame defined e.g. by the CFN, the base station deletes the frame and sends a notification of this to the controller so that the controller may advance or delay the transmission of the subsequent FP frames accordingly. An example of the adjustment procedure is discussed in mode detail in the above refereed 3GPP (3rd Generation Partnership Project) TS 25.427 Specification titled ‘Group Radio Access Network; UTRAN Iub/Iur Interface User Plane Protocol for DCH Data Streams (version 3.1.0 Release 1999)’.

At current no mechanism has been proposed how to prioritise different simultaneous frame protocol connections. However, the inventor has found that the handling order of the data streams and/or data content thereof, i.e. traffic handling priority, could be useful in various occasions in order to differentiate various connections from each other. The traffic handling priority may be defined as a feature that specifies the relative importance for handling of service data units (SDUs) belonging e.g. to a UMTS radio access bearer (RAB) compared to the SDUs of other bearers. The service data units (SDUs) may comprise a data packet or any other data transmission entity that may be seen as forming an information unit.

The inventor has also found that the currently proposed transport network layer may not be used in the most efficient manner in all occasions. For example, the available transmission capacity of the interface may not be used in an efficient/optimised manner when more than one frame protocol connection occur at the same time. Since no differentiation is available, all services (e.g. radio bearers conveying the services) typically need to be transmitted with a similar quality of service (QoS) parameters. That is, with the similar transfer delay requirement the QoS would be determined by the most stringent service, even though not all services may require this. As a result the needed amount of bandwidth in the packet switched media may be significantly bigger than what might be required if some kind of service differentiation could be used. The inventor has found that the service differentiation may allow the system to benefit from statistical multiplexing that is available in the packet switched transport systems. In addition, timing information that is based on parameters received from the core network side may not always provide an appropriate base for the timing to be used by the nodes of the radio access network.

### SUMMARY OF THE INVENTION

It is an aim of the embodiments of the present invention to address one or several of the above problems.

According to one aspect of the present invention, there is provided a method for transporting information in a packet switched communication system comprising a plurality of nodes, wherein information is transmitted by first transport entities from the first node to the second node and by second transport entities further from the second node, the method comprising: defining allowed transportation delays for the first transport entities; distributing, in the first node, the first transport entities into a plurality of transportation classes based on information of the allowed transportation delays; assigning an indicator for a transport entity to be transported from the first node to the second node based on information of the transportation class thereof and information of a transport entity of said second transport entities that is to be transported from the second node at a given moment of time; transporting said transport entity from the first node to the second node; and receiving the transport entity at the second node and inserting information in said received transport entity into a transport entity of the second transport entities based on the indicator.

According to another aspect of the present invention there is provided a communication system, comprising: a first node and a second node, wherein information is transmitted by first transport entities from the first node to the second node and by second transport entities further from the second node; means for defining allowed transportation delays for the first transport entities; in the first node, means for distributing the first transport entities into a plurality of transportation classes based on information of the allowed transportation delays; means for assigning an indicator for a transport entity to be transported from the first node to the second node based on information of the transportation class thereof and information of a transport entity of said second transport entities that is to be transported from the second node at a given moment of time; interface between the first and second nodes for transporting said transport entity from the first node to the second node; and means for inserting information in the transport entity received at the second node into a transport entity of the second transport entities based on the indicator.

The embodiments of the invention may improve the transport efficiency of the transport network layer, for example such that the efficiency in using of the available transmission capacity of the interface is improved. By means of use of the differentiation all services may not need to be transmitted with a similar service characteristics, but different service parameters may be assigned to different services. The embodiments may enable differentiation of various bearers from each other. For example, the embodiments enable an arrangement in which the most stringent service does not define the quality of service parameters for all radio bearers with a similar transfer delay requirement. The prioritisation between different service classes may enable more efficient use of the transport resources, since the statistical multiplexing gain may be increased. As a result the needed amount of bandwidth in the packet switched media may be less than in the case where no service differentiation is used. This may be the case especially in interfaces within a radio access network. In addition, the embodiment may enable adjustment of timing parameters so as to match better to the internal conditions of a subnetwork of the communication system.

### BRIEF DESCRIPTION OF DRAWINGS

For better understanding of the present invention, reference will now be made by way of example to the accompanying drawings in which:

FIG. 1 shows a communication system in which the embodiments of the present invention may be implemented;

FIG. 2 is a schematic illustration of queues in a access network node;

FIG. 3 illustrates an example of transport entities; and

FIG. 4 is a flowchart illustrating the operation of one embodiment of the present invention.

### DESCRIPTION OF PREFERRED EMBODIMENTS OF THE INVENTION

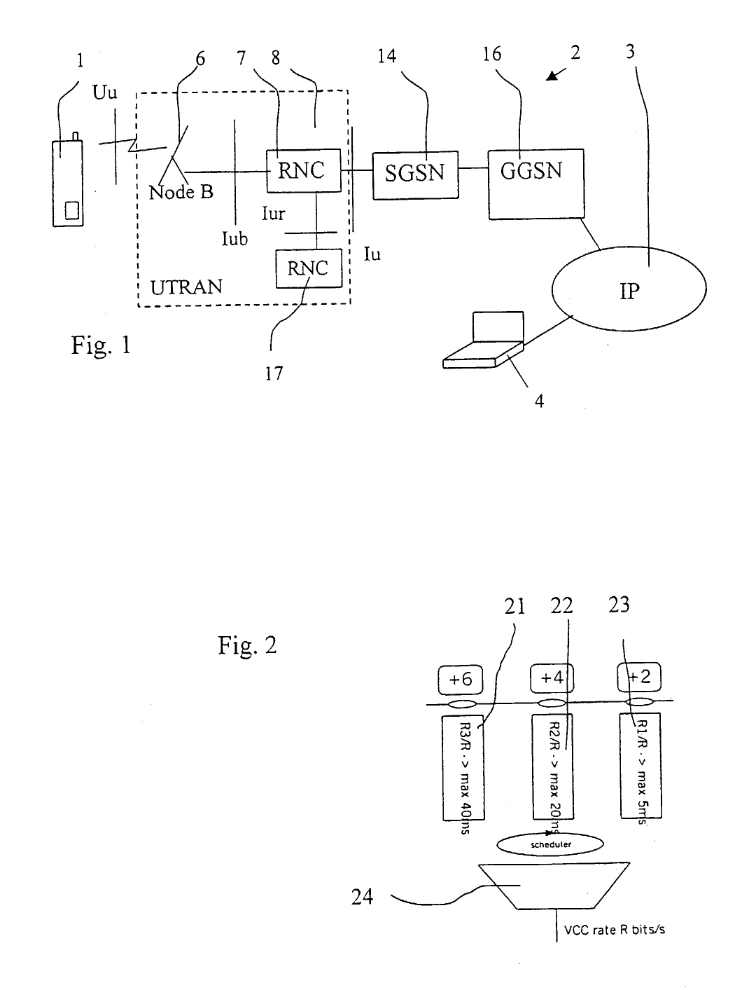

Reference is first made to FIG. 1 which shows a communication system that provides resources for packet switched communication and in which the embodiments of the present invention may be employed. FIG. 1 system is capable of providing wireless packet switched services for a user 1 thereof by means of a public land mobile networks (PLMN) 2. A user 4 is provided with fixed line packet switched services by means of a data network 3. It should be appreciated that while the embodiments of the invention are described in the context of a UMTS (Universal Mobile Telecommunications System) and more specifically, with reference to ATM/AAL2 based UTRAN (UMTS terrestrial access network), the embodiments of the present invention are applicable to any other packet switched communication system which deals with packet data.

Some of the elements of a UMTS PLMN system 2 will be discussed briefly in the following with reference to FIG. 1. A mobile station or other appropriate user equipment 1 is arranged to communicate via the air interface with a transceiver element 6 of the PLMN system. It should be appreciated that the term mobile stations is indented to cover any suitable type of wireless user equipment, such as portable data processing devices or web browsers and various types of mobile telephones. The area covered by the PLMN system 2 may be divided into a plurality access entities (not shown), typically referred to as cells. Each access entity has associated therewith a transceiver element 6, typically referred to as base station or node B. The term base station will be used in this document to encompass all elements which transmit to and/or receive from wireless stations or the like via the air interface.

The base station is controlled by a radio network controller node (RNC) 7 over an Iub interface there between. The radio network controller 7 and the base station are a part of an access network 8 such as the UMTS Terrestrial Radio Access Network UTRAN. The controller 7 may also communicate with a second controller 17 of the access network over an Iur interface. The Iur interface may divide the access network into two or several radio network subsystems (RNS), each subsystem typically including one radio network controller RNC. Use of ATM/AAL2 in the UTRAN is given as an example of the possible protocol, although other protocols, such as the IP protocol, may be used in the UTRAN 8. The use of ATM/AAL2 in the UTRAN environment means that a type 2 ATM adaptation layer is on top of the ATM layer in a manner that is similar e.g. to arrangements where a UDP (user datagram protocol) layer is on top of an IP layer.

It should be appreciated that a UMTS network is typically provided with more than one access network, that an access network may comprise any appropriate number of controllers and that each radio network controller is arranged generally to control more than one base station 6. If more than one RNC is provided, they all may communicate with each other over an Iur interface provided there between. The distribution of the various elements of the UTRAN 8 is an implementation issue.

The radio access network 8 is connected to a core network of the system over an appropriate interface. In the UMTS specifications this interface is typically referred to as an Iu interface. The connection over the Iu interface may be provided between the RNC 7 and a SGSN (serving GPRS support node) 14. Among other functions, the SGSN 14 keeps track of the mobile station's location and performs security functions and access control. The SGSN 14 is shown to be connected to a GGSN (gateway GPRS support node) 16. The GGSN 16 provides interworking with the other packet switched network 3. In other words, the GGSN 16 acts as a gateway between the UMTS network 2 and the other data network 3, such as an IP based data network.

Another user terminal 4 is shown to be connected to the data network 3. The exemplifying arrangement is such that the terminals 1 and 4 may communicate via the packet switched networks 2 and 3. However, it should be appreciated that embodiments of the invention may be applied to other types of packet switched communication arrangements as well, such as to an arrangement where the user 1 (or 4) communicates with an element that is implemented within the network 2 (or 3) or to an arrangement where two elements of the network 2 (or 3) communicate internally within the network.

Although not shown, the network system 2 may also be connected to conventional telecommunication networks, such as to a GSM based cellular public land mobile network (PLMN) or to a public switched telephone network (PSTN). The various networks may be interconnected to each other via appropriate interfaces and/or gateways.

A transport channel such as a dedicated (transport) channel (DCH) may be established between the radio access network 8. and the user equipment 1. In order to keep the synchronisation of the data stream of the dedicated channel DCH the RNC 7 includes a Connection Frame Number CFN to all DCH FP frames that are transmitted in the downlink, i.e. from the RNC 7 towards the user equipment 1. The used frame protocol may provide, among other functions, support for a transport channel synchronisation mechanism and/or support for a node synchronisation mechanism. The timing parameters of the frame protocol may be used to define a window within which the data packets belonging to a data stream should have been received. The CFN can be defined as a frame indicator that contains information of the radio frame in which the data in the FP frame shall be transmitted further from the base station on the downlink. If a downlink data frame arrives outside a determined arrival window to the base station, the base station 6 may report a measured time of arrival ToA and the indicated CFN e.g. in a so called uplink UL DCH FP control frame. This possible timing adjustment procedure is described in more detail in the above referenced 3GPP TS25.427 specification. The following will outline the main features of this possible adjustment window arrangement.

The measured time of arrival ToA can be defined as the time difference between an end point of a downlink arrival window (this may be referred to as Time of Arrival Window Endpoint: ToAWE) and the actual arrival time of the downlink frame for a specific CFN. A positive ToA means that the FP frame is received before the ToAWE. A negative ToA means that the FP frame is received after the ToAWE. The ToAWE typically represents the time point by which the downlink data should have arrived to the base station from the Iub interface between the PNC 7 and the base station 6. The ToAWE may be defined as the amount of milliseconds before the last time point from which a timely downlink transmission for the identified CFN would still be possible. The internal delays of the base station or any other predefined parameters may be taken into account in here. The ToAWE may be set via a control plane. If the data does not arrive before the endpoint set forth by the ToAWE, a Timing Adjustment Control Frame TACF may be sent by the base station 6 to the RNC 7. A Time of Arrival Window Startpoint (ToAWS) parameter represents the time after which the downlink data shall arrive to the base station 6 from the Iub. The ToAWS is typically defined as the amount of milliseconds from the ToAWE. The ToAWS may also be set via the control plane. If the data arrives before the point defined by the ToAWS, a Timing Adjustment Control Frame may be sent by the base station to the RNC 7 (cf. the ToAWE).

Referring now also to FIG. 2, the following describes a mechanism for quality of service (QoS) differentiation in the packet switched transport system that may be used for example in the UMTS Terrestrial Radio Access Network (UTRAN) or a GPRS/EDGE Radio Access Network (GERAN). The embodiments may gain benefit in the transport efficiency by taking into account possible individual requirements of the different radio bearers that are setup in the system. The prioritisation into different service classes in accordance with the maximum delay of the call may increase the efficiency since the statistical multiplexing gain increases, and thus the bandwidth (transmission bitrate) requirement at the Iub interface may decrease. In addition, by means of the differentiation it may be possible to take into account the less strict delay requirements of non-realtime (NRT) data transportation.

However, the prioritisation may not be enough alone since the frame protocol layer is delay sensitive (e.g. due to the frame indicator set by the RNC and the size of the delay window that is set when establishing the radio link). In the embodiments described below this is addressed by taking the different delays of the transport layer into account for each call by introducing so called frame indicator offset. By means of the indicator offset it may be possible to decrease the amount of notifications by the base station (or other node) regarding FP frames that have arrived too late or too early.

The differentiation mechanism may involve both the transport layer and the radio network layer of the protocol stack, as there is interaction between the Frame Protocol (FP) procedures at the Radio Network layer and the transport performance at the transport layer (for the interaction, see the timing adjustment procedures described above). The service is not differentiated at the frame protocol layer but rather in the transport layer by selection of an appropriate transportation queue for the frame protocol connection. This means that although the frame protocol layer may be used in the mechanism, it does not need to be used for other purposes than for signalling the frame indicator to another node in the radio access network. The frame protocol layer may be only indirectly involved since the indicator (CFN) and/or the offset thereof is defined based on the selected differentiation class.

In the exemplifying embodiments a protocol (transport layer user) is on the radio network layer that is delay sensitive and the user operations may be dependent on the underlying transport layer delay performance. The offset of the FP frame indicator is preferably chosen in accordance with an expected maximum delay. The maximum delay may be determined by selecting the transport layer queue/scheduling discipline (e.g., service category). The transport layer service category may be selected based on various service characteristics, such as tolerated delay, the size of the frame payload, service data unit (SDU) size, amount of information to be transported in a data bearer, amount of payload in a FP frame, error tolerance, urgency of the data, importance of the data and so on.

FIG. 2 illustrates a possibility for differentiating the various frames into various transport service classes of a transport layer of the protocol stack. It should be appreciated that the embodiment is described in the context of the radio network controller 7 of FIG. 1, although the same scheme may be applied in other nodes of the packet switched communication system as well. The distribution of the frames is based on the allowed maximum delay of the data connection. Information concerning the allowed maximum delay may be obtained from the core network, e.g. as quality of service (QoS) information.

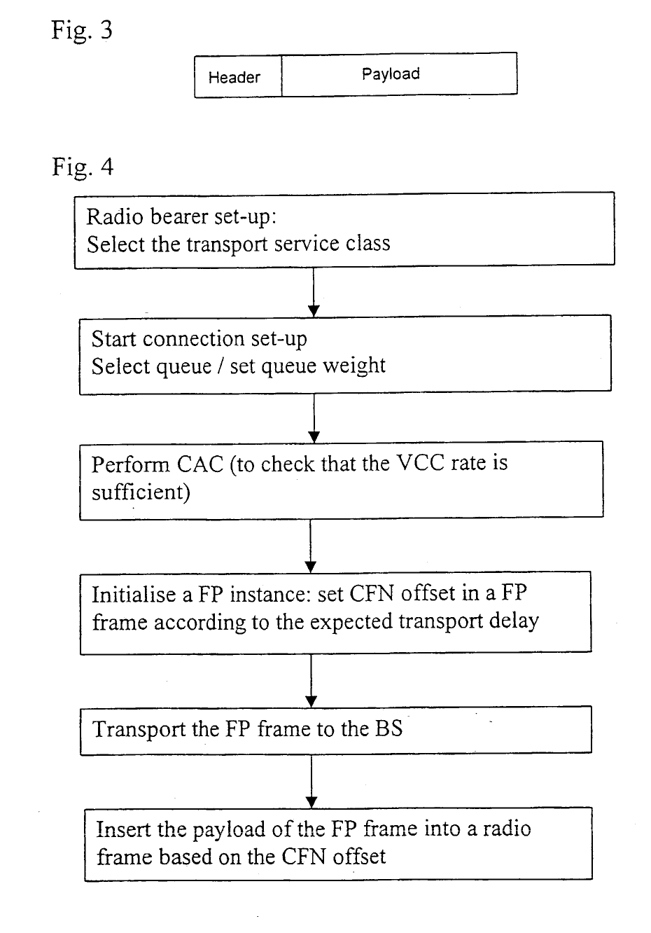

Before explaining the queues of FIG. 2 in more detail, a brief reference is made to FIG. 3 illustrating the general structure of a possible transport entity. The exemplifying DCH FP frame consists of a header portion and a payload portion. The header may contain various information that is required for controlling the transportation of the frame, such as a CRC checksum, the frame type field (control frame, data frame) and information related to the frame type. The payload portion of FP data frames may contain various information to be transported between nodes. The payload of control frames contains commands and measurement reports related to transport bearer and the radio interface physical channel but not directly related to specific radio interface user data.

Returning now to FIG. 2, in the illustrated example three transport queues 21 to 23 are used for differentiating the FP frames from each other. The queue 21 is for data bearers that allow maximum delay of 40 ms, the queue 22 is for bearers that allow maximum delay of 20 ms and the queue 23 is for bearers that allow a maximum delay of 5 ms. A scheduler 24 is for the selecting frames from the queues based on a predefined scheme to be transported to the base station.

The service differentiation may be implemented by means of the transport layer. In order to make the radio network layer work properly on top of the transport layer it is necessary to couple these two layers together in an appropriate manner. This may be accomplished as follows. The Frame Protocol (FP) layer instance is made aware of the expected transport delay of the FP frames thereof. By means of this the FP layer may set the Connection Frame Number (CFN) of the FP frames that are about to depart the RNC queues accordingly. The CFN in the FP frame before or after the payload (i.e. in the header or in the trailer of the frame) indicates in the receiving peer the radio frame in which the payload of the given FP frame is to be sent over the radio interface towards the user equipment 1. The queuing may cause a delay depending on the selected queue and/or weight set for the queue.

If the transport layer queuing delay is not taken into account when setting the CFN, the FP frames may arrive too late in the base station 6. This may result in the above described procedure for Timing Adjustment between the peer FP instances and may cause loss of data and/or unnecessary reservation of bandwidth. This delay may be addressed by an off-set that is assigned for the CFN indicator. The following describes a practical example how this may be accomplished.

Lets assume that the transport layer defines a service class that ensures 20 ms transport delay over the Iub interface. The off-set of the delay may be measured in radio frames (the example assumes a radio frame that has a length of 10 ms). In this case the frame indicator offset i.e. CFN-offset of the corresponding FP connection is set such that this delay is taken into account. This may be accomplished e.g. such that the RNC 7 assigns to all FP frames that are departing from the RNC 7 and that associate with the connection a frame indicator CFN in accordance with the scheme CFN=CFN(i)+3, wherein CFN(i) indicates the radio frame that is to be transmitted at the same time over the radio link between the base station 6 and the user equipment 1. Now, since the maximum delay is 20 ms, and the frame indicator is set so that the transportation of the radio frame is to be offset 3*10 ms. By means of this the FP frame should have arrived by the time the assigned radio frame is to be transported from the base station.

In addition to offsetting the delay, it is possible to adjust the size of the receiving window of the base station during the radio link set-up such that the base station will not react too “sensitively” to frames that arrive too early. A frame may arrive too early e.g. since data in a selected queue can in some instances be transported faster than expected, whereby the transport between the nodes occurs faster than e.g. in the above mentioned 20 ms (the queuing is typically a statistic process with a certain distribution for the expected queuing time). The set 20 ms maximum delay means that the probability for exceeding the 20 ms is relatively small. However, in some instances this may mean that the probability for a too early arrival in the base station increases.

FIG. 4 shows a flowchart that illustrates further the principles of the above described procedure. During the connection set-up the corresponding transport layer service class is determined. The determination may be based, for example, on the Radio Access Bearer parameters or the determined Radio Bearer parameters. This depends on the implementation of the RNC node. Thereafter either one of the existing transport layer queues (service or connection specific) may be selected or a new queue may be created or the weight of an existing queue may be modified. Connection Admission Control (CAC) may also be performed at this stage in order to check and reserve the resources that are required by the new transport connection. After this the connection set-up signalling towards the peer node, e.g. the base station or another RNC, can be started. The set-up signalling is used for sending information of the transport service class. To give an example, but without limiting to these, this information can be conveyed in messages such as ‘NBAP Radio Link Setup Request [transport channel information]’, ‘Q.aal2 Establish Request [AAL2 path characteristics] or [Served User Transport]’, depending on the application. In the above the NBAP is an abbreviation of node B application protocol and SUT is an abbreviation of Served User Transport. Q.aal2 refers to AAL2 Signalling protocol that has been specified in ITU-T (International Telecommunication Union) Recommendation Q.2630. Q.aal2 is the transport network signalling protocol that may be used in the UTRAN Release 99 for the signalling between the access network nodes.

The Served User Transport (SUT) parameter of Q.aal2 can be used for this purpose as it has been specified to convey information transparently between the two peer served users. A possibility would be to map the transport service class to the AAL2 Path Characteristics parameter that has been introduced in Q.aal2 CS-2 (capability set 2). However, this specific mechanism may be applicable only in the non-switched scenario of using AAL2 signalling and other application may require different implementations. In this approach the number of service classes may be by default two(stringent or tolerant). It is emphasised that the AAL2 Path Characteristics have been originally specified by ITU-T (International Telecommunication Union) for AAL2 Path selection (i.e., ATM VCC; asynchronous transfer mode virtual channel connection) rather than for the selection of AAL2 CPS queue.

Coupling may be needed between the transport layer queue selection and the Radio network layer scheduling also if so called Layer 1 multiplexing is applied in the radio interface between the base station 6 and the user equipment 1. Layer 1 multiplexing refers to a technique where more than one transport channel becomes mapped to the same radio frame in the radio interface. These frames need to be available in the base station at the same time even though the frames may be transported via separate transport channels on Iub and/or Iur interfaces.

A queue that associates with a service class may represent a given ATM connection (e.g. ATM VCC) to which the AAL2 connections of said class (i.e. connections that are transported through the same queue) are multiplexed. The queue may also represent a certain part of AAL2 connections that are transported through an ATM VCC. In other words, in the latter scenario all classes share the same ATM VCC but the different AAL2 connections have different priorities.

The new FP instance may be initialised according to the delay performance of the selected transport service class. The delay performance of the transport service class is determined by the queue service discipline and the serving rate. The rate may be defined e.g. by weight if a weighting scheme such as Weighted Fair Queuing is used. The weighting function may be implemented such that the weights of the queues are configurable by the user of the network element (e.g. the operator of the network 2 or the user of the mobile station 1). Dynamic adjustment of the weights of the queues may also be enabled, e.g. in accordance with the amount of data in the queues. The weights of the queues may be assigned and/or the dynamic changing of the weights is preferably implemented during the activation/deactivation of the data bearers i.e. the logical connections between the core network and the user equipment.

The above described mechanism is needed in order to be able to benefit from the service differentiation along a path from the originating node to the destination node (e.g. in a path over the Iub between the RNC 7 and the base station 6). The differentiation may be based e.g. on the chosen delay or the quality of service QoS parameter or class. The signalling of the selected transport service class to the peer node (BS) can be performed in several ways. For example, Node B Application Protocol (NBAP) or a RNSAP in case of an Iur interface between two radio access network nodes can be used. The use of already existing protocols may require addition of an appropriate transport priority information element into the corresponding protocol message (e.g. Radio Link Addition).

It is noted that the above disclosed solution is applicable also in any IP (Internet Protocol) based transport environment. The above described queuing scheme may be implemented by, for example, IP Differentiated Service architecture, where each queue is then mapped into a certain Per-Hop-Behaviour (PHB) feature of an IP DiffServ application. In general, the embodiments may be implemented independently of the type of the used transport protocol.

It should be appreciated that whilst embodiments of the present invention have been described in relation to FP frames and radio frames, embodiments of the present invention are applicable to any other suitable type of transport entities between two or more nodes. In addition, although the embodiments relate to wireless user equipment, embodiments of the present invention are applicable to any other suitable type of user equipment. The embodiments of the invention have discussed the interface between the radio network controller and the base station of the radio access network. Embodiments of the present invention can be applicable to other network elements where applicable. The communication may be in the uplink direction, in the downlink direction or within the access network or any other network entity comprising at least two nodes.

It is also noted herein that while the above describes exemplifying embodiments of the invention, there are several variations and modifications which may be made to the disclosed solution without departing from the scope of the present invention as defined in the appended claims.

1. A method for transporting information in a packet switched communication system comprising a plurality of nodes, wherein information is transmitted by first transport entities from the first node to the second node and by second transport entities further from the second node, the method comprising:
defining allowed transportation delays for the first transport entities;
distributing, in the first node, the first transport entities into a plurality of transportation classes based on information of the allowed transportation delays;
assigning an indicator for a transport entity to be transported from the first node to the second node based on information of the transportation class thereof and information of a transport entity of said second transport entities that is to be transported from the second node at a given moment of time;
transporting said transport entity from the first node to the second node; and
receiving the transport entity at the second node and inserting information in said received transport entity into a transport entity of the second transport entities based on the indicator.

2. A method as claimed in claim 1, wherein the information in the indicator associates with an offset required for compensating the allowed delay of said transport entity at the second node.

3. A method as claimed in claim 1 or 2, wherein the first transport entities comprise frames of a frame protocol layer.

4. A method as claimed in any preceding claim, wherein the second transport entities comprise radio frames.

5. A method as claimed in any of claims 2 to 4, wherein the offset is expressed as a number of radio frames.

6. A method as claimed in any preceding claim, wherein the first transport entities are distributed into transportation queues in the first node, each queue being assigned for a transportation class based on a priority criteria.

7. A method as claimed in any preceding claim, wherein the first node is made aware of the transport entity that is to be transported further from the second node at the same time as a transport entity is to be transported from the first node to the second node.

8. A method as claimed in any preceding claim, wherein the first node generates the indicator to be assigned for said transport entity.

9. A method as claimed in any preceding claim, wherein the indicator includes a parameter for use in compensation of the allowed delay of said transport entity.

10. A method as claimed in any preceding claim, wherein the transport entities are distributed into said plurality of transportation classes in a transport layer.

11. A method as claimed in claim 10, wherein the indicator is transported in a frame protocol layer.

12. A method as claimed in any preceding claim, wherein the indicator comprises an order number, the transport entities being transported sequentially from the second node in an order that is defined by said order number.

13. A method as claimed in claim 12, wherein the first node generates the order number based on information of the order number of the transport entity to be transported from the second node.

14. A method as claimed in claim 12 or 13, wherein the first node generates the order number based on information of the transportation interval between the transport of two subsequent transport entities from the second node.

15. A method as claimed in any preceding claim, comprising setting a timing window for the arrival of the transport entity in the second node, said timing window defining a period within which the transport entity is acceptably received at the second node.

16. A method as claimed in preceding claim, wherein the information entities to be transported from the first node comprise a payload portion, and wherein the indicator is inserted into the transport entity either before or after the payload portion.

17. A method as claimed in any preceding claim, wherein the distribution of the transport entities into the transportation classes is also based on at least one of the following: amount of information to be transported by frames of a data bearer; amount of data packets contained in a frame; error tolerance; size of frame payload; urgency of the information; importance of the information.

18. A method as claimed in any preceding claim, wherein the first and second nodes are comprised in a radio access network.

19. A method as claimed in claim 18, wherein the first node comprises a radio network controller and the second node comprises a base station.

20. A method as claimed in claim 19, wherein the base station transports the transport entities further to a user equipment via a wireless link at a moment of time that is defined based on the indicator.

21. A method as claimed in claim 20, wherein the radio network controller controls the establishment of the wireless link between the radio access networks and the user equipment, the distribution to different transportation classes being accomplished in a transport layer of the protocol layer stack of the radio access network.

22. A method as claimed in claim 18, wherein the first node comprises a base station and the second node comprises a radio network controller.

23. A method as claimed in claim 18, wherein the first and second nodes each comprise a radio network controller.

24. A method as claimed in any preceding claim, wherein at least one transportation of the transport entities is based on the Internet Protocol.

25. A method as claimed in any of the preceding claims, wherein the information entities are distributed in the first node into a plurality of transportation queues based on quality of service parameters.

26. A method as claimed in any preceding claim, comprising multiplexing more than one transport channel into a transport entity.

27. A method as claimed in any preceding claim, comprising the step of setting weights to at least one of the transportation classes.

28. A communication system, comprising
a first node and a second node, wherein information is transmitted by first transport entities from the first node to the second node and by second transport entities further from the second node;
means for defining allowed transportation delays for the first transport entities;
in the first node, means for distributing the first transport entities into a plurality of transportation classes based on information of the allowed transportation delays;
means for assigning an indicator for a transport entity to be transported from the first node to the second node based on information of the transportation class thereof and information of a transport entity of said second transport entities that is to be transported from the second node at a given moment of time;
interface between the first and second nodes for transporting said transport entity from the first node to the second node; and
means for inserting information in the transport entity received at the second node into a transport entity of the second transport entities based on the indicator.

29. A communication system as claimed in claim 28, wherein the information included in the indicator associates with an offset that is required for compensating allowed delay of said transport entity at the second node.

30. A communication system as claimed in claim 29, wherein the offset information comprises a parameter that is based on radio frames.

31. A communication system as claimed in any of claims 29 to 30, wherein the first node is adapted to generate the indicator to be assigned for said transport entity.

32. A communication system as claimed in any of claims 29 to 31, wherein the first transport entities comprise frames of a frame protocol layer and the second transport entities comprise radio frames.

33. A communication system as claimed in any of claims 29 to 32, wherein transportation queues that are assigned each for a transportation class are provided by the first node, the first node being adapted to distribute the first transport entities into in the queues.

34. A communication system as claimed in any of claims 29 to 33, wherein the first node is provided with information concerning the transport entity that is to be transported further from the second node at the same time as a transport entity is to be transported from the first node to the second node.

35. A communication system as claimed in any of claims 29 to 34, wherein the indicator comprises an order number, the arrangement being such that transport entities are transported sequentially from the second node in an order that is defined by said order number.

36. A communication system as claimed in any of claims 29 to 35, comprising means for setting a timing window for the arrival of the transport entity in the second node, said timing window being adapted to define a period within which the transport entity is acceptably received at the second node.

37. A communication system as claimed in any of claims 29 to 36, wherein the first and second nodes are comprised in a radio access network.

38. A communication system as claimed in any of claims, wherein the first node is adapted to distribute the transport entities into the plurality of transportation classes based on quality of service parameters.
